(19) United States
(12) Patent Application Publication
(10) Pub. No.: US 2026/0249443 A1
(43) Pub. Date: Aug. 27, 2026

(54) POLE ASSEMBLY FOR A GARDENING TOOL

(71) Applicant: sWaoff, LLC, Waltham, MA (US)

(72) Inventor: Frank Fragale, Waltham, MA (US)

(21) Appl. No.: 19/550,447

(22) Filed: Feb. 26, 2026

Related U.S. Application Data
(60) Provisional application No. 63/763,664, filed on Feb. 26, 2025.

(51) Int. Cl. B25G 1/08; A01G 3/047; B25G 1/04

(52) U.S. Cl. CPC B25G 1/08; A01G 3/0475; B25G 1/04

(57) ABSTRACT

A pole assembly for a handheld gardening tool includes an elongated tubular pole adapted to receive a pivotable gardening head. A hollowed, frustoconical handle is mounted onto the free end of the pole and includes an open top end that provides access to an interior compartment dimensioned to receive a small handheld gardening instrument, such as gardening clippers or pruning shears. To limit downward displacement of the instrument within the interior compartment, a solid cylindrical insert is fittingly mounted within the interior compartment at the bottom end of the handle. To enclose the handle, a cap is removably mounted onto the top end. By pivoting the gardening head in a variety of positions, the pole assembly can be utilized to execute a wide range of gardening activities, such as raking, edging, and digging. Furthermore, by removing the small handheld instrument from the handle, plant trimming can also be performed.

### CROSS-REFERENCE TO RELATED APPLICATIONS

The present invention claims the benefit under 35 U.S.C. 119(e) to U.S. Provisional Patent Application No. 63/763,664, which was filed on Feb. 26, 2025, in the name of Frank Fragale, the disclosure of which is incorporated herein by reference.

### FIELD OF THE INVENTION

The present invention relates generally to handheld gardening tools and, more particularly, to poles, or handles, for handheld gardening tools.

### BACKGROUND OF THE INVENTION

Individuals that engage in landscaping activities often require a large variety of different handheld gardening tools to perform standard gardening tasks. Examples of well-known and widely used gardening tools include, but are not limited to, rakes, aerators, edgers, and hoes. As can be appreciated, the requirement that a landscaper possess a large number of individual gardening tools introduces significant issues with respect to storage, handling, and cost.

Consequently, multi-purpose gardening tools are commonly utilized to simplify landscaping activities. For example, in U.S. Pat. No. 7,987,658 to F. Fragale, the disclosure of which is incorporated herein by reference, there is disclosed a single, multi-purpose tool with a pivotable gardening head. The head is a unitary member that includes a semi-circular edger plate and a comb-like rake. By pivoting the gardening head in a variety of fixed positions relative to the pole, a plurality of distinct gardening instruments can be created.

Although multi-purpose gardening tools of the type as described above are designed to assist in a wide array of gardening tasks, it has nonetheless been found that certain gardening activities cannot be readily undertaken using conventional multi-purpose gardening tools. Notably, the trimming and pruning of bushes and shrubs cannot be typically handled using traditional multi-purpose gardening tools. Instead, separate handheld tools are required to perform conventional trimming and pruning tasks. As a result, a gardener is typically required to routinely carry multiple individual gardening instruments, which introduces significant storage and handling issues.

### SUMMARY OF THE INVENTION

In view thereof, it is an object of the present invention to provide a novel gardening tool that is equipped to handle an array of different gardening tasks including, but not limited to, raking, aerating, edging, digging, weeding, trimming, and pruning.

It is another object of the present invention to provide a novel gardening tool of the type as described above wherein multiple individual gardening instruments are integrated into a single handheld unit.

It is yet another object of the present invention to provide a novel gardening tool of the type as described above that is compact in size.

It is still another object of the present invention to provide a novel gardening tool of the type as described above that has a limited number of parts, is inexpensive to manufacture, and is easy to use.

Accordingly, as one feature of the present invention, there is provided a pole assembly for a handheld gardening tool, the pole assembly comprising (a) an elongated tubular pole having a first end and a second end, (b) a handle, the handle being hollowed out along its length so as to define an interior compartment, the handle having an open, inwardly tapered, bottom end and an open, widened, top end, the bottom end being mounted over the second end of the elongated tubular pole in a telescoping fashion, the handle having an interior wall that includes an inwardly-protruding lip, and (c) a cap removably mounted onto the top end of the handle so as to enclose the interior compartment, (d) wherein the interior compartment of the handle is adapted to receive a small handheld gardening instrument.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIGS. 1A and 1B are top perspective and front plan views, respectively, of a pole assembly constructed according to the teachings of the present invention;

FIGS. 2A and 2B are top perspective and front plan views, respectively, of the pole shown in FIG. 1A;

FIGS. 3A-3D are top perspective, top plan, front plan, and longitudinal section views, respectively, of the handle shown in FIG. 1A;

FIG. 4 is a top perspective view of a wooden insert for use with the pole assembly shown in FIG. 1A;

FIGS. 5A-5D are top perspective, top plan, front plan, and longitudinal section views, respectively, of the cap shown in FIG. 1A;

FIG. 6 is a top perspective view of the paracord loop shown in FIG. 1A;

FIG. 7 is a fragmentary, front view of the pole assembly shown in FIG. 1A, wherein hidden portions of its interior are shown in dashed form, the pole assembly being shown retaining a handheld pruning clipper shown in dashed form; and

FIGS. 8A-8D are top perspective, front plan, top plan, and right-side views, respectively, of the pruning clipper shown in FIG. 7.

### DETAILED DESCRIPTION OF THE INVENTION

### Pole Assembly 11

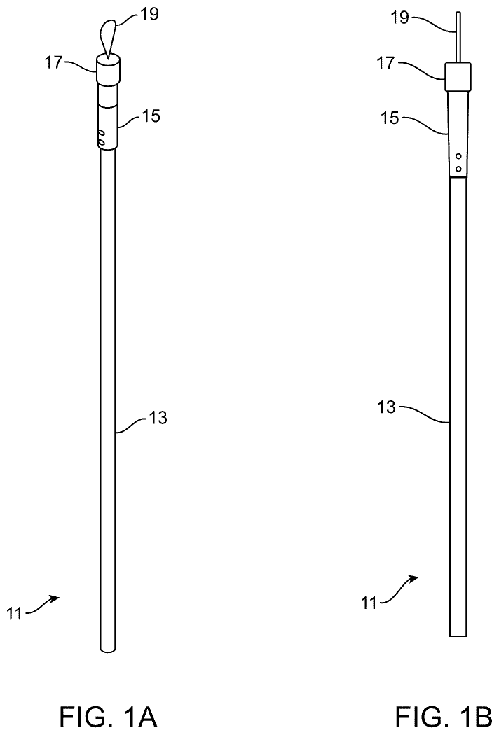

Referring now to FIGS. 1A and 1B, there are shown top perspective and front plan views, respectively, of a pole assembly constructed according to the teachings of the present invention, the pole assembly being identified generally herein by reference numeral 11. Pole assembly 11 is designed primarily to serve as an elongated handle for a multi-purpose gardening tool. As a principal feature of the invention, pole assembly 11 is configured with an interior compartment that is dimensioned to receive a small handheld instrument, such as pruning clippers or gardening shears. As a result, pole assembly 11 provides a single, multi-purpose gardening tool with an even wider array of gardening capabilities.

In the present disclosure, pole assembly 11 is described as being designed primarily for use as an elongated handle for a multi-purpose gardening tool. However, it should be noted that pole assembly 11 is not limited to use with multi-purpose gardening tools. Rather, it is to be understood that pole assembly 11 could be utilized in any suitable application that requires an elongated tubular-type handle without departing from the spirit of the present invention.

Furthermore, it should be noted that the interior compartment in pole assembly 11 is not limited to retaining small, handheld gardening instruments, such as clippers or shearers. Rather, it is to be understood that the interior compartment in pole assembly 11 could be utilized to retain any useful item of limited size without departing from the spirit of the present invention.

As can be seen, pole assembly 11 comprises (i) an elongated tubular pole 13, (ii) a handle 15 mounted over one end of tubular pole 13 in a telescoping fashion, (iii) a cap 17 removably mounted onto handle 15, and (iv) a paracord loop 19 connected to cap 17. As will be described in detail below, handle 15 includes an interior compartment that is configured to retain a small handheld gardening instrument. As a result, pole assembly 11 not only serves as an elongated handle for manipulating the tool head to which it is coupled, but also as a vessel for removably holding a small handheld item.

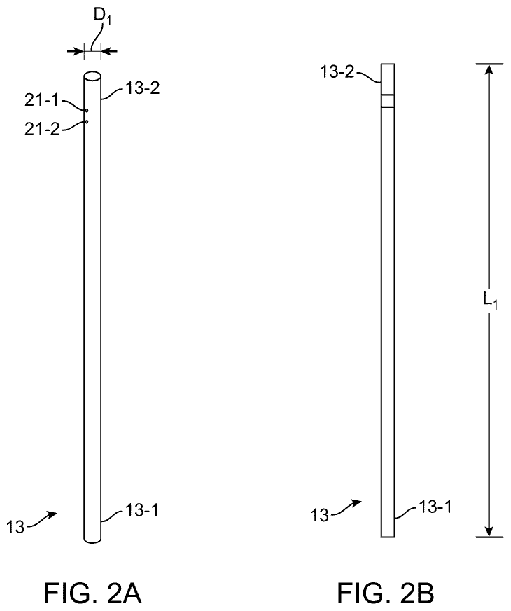

Referring now to FIGS. 2A and 2B, pole 13 is an elongated, hollowed, tubular member that is preferably constructed of a rigid and durable material, such as fiberglass. Pole 13 has an overall length L₁ of 41.012 inches and a uniform outer diameter D₁ of 1.25 inches along the entirety of its length.

Pole 13 is hollowed out for the entirety of its length and includes a first end 13-1 and a second end 13-2. First end 13-1 is adapted to be readily coupled to a gardening head to form a multi-purpose gardening tool (e.g., of the type shown in U.S. Pat. No. 7,987,658 to F. Fragale). A pair of holes 21-1 and 21-2 extends laterally through pole 13 at second end 13-2 and facilitates construction of pole assembly 11, as will be explained further below.

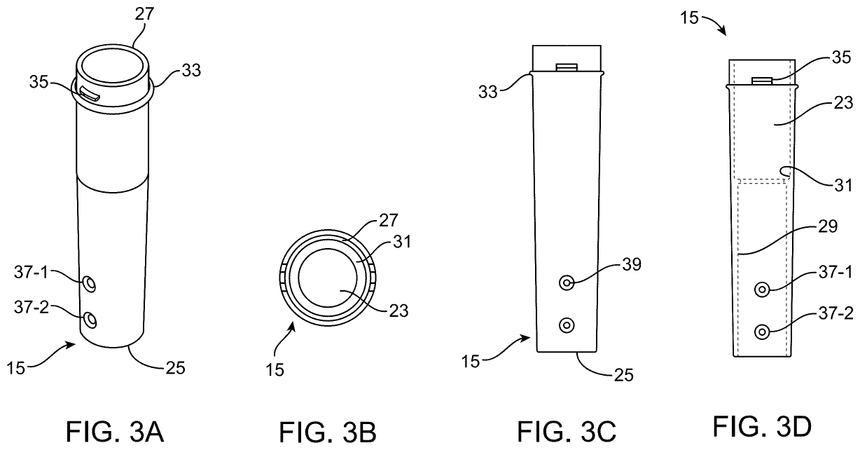

Referring now to FIGS. 3A-3D, handle 15 is a hollowed, generally frustoconical member that is mounted over second end 13-2 of pole 13 in a telescoping manner. Handle 15 is preferably constructed of any suitable material with the requisite strength and comfort for gripping and manipulating pole assembly 11, such as a co-polymer polypropylene. Preferably, the outer surface of handle 15 is textured or otherwise treated to provide an adequate grip for the operator. As referenced previously, handle 15 is shaped with an interior compartment, or longitudinal cavity, 23 which is dimensioned to removably retain a small handheld instrument, such as gardening clippers or pruning shears. As such, pole assembly 11 provides a tool with enhanced gardening capabilities.

Hollowed, frustoconical handle 15 has an open, inwardly tapered, bottom end 25, which is dimensioned to fittingly mount over second end 13-2 of pole 13, and an open, slightly widened, top end 27 which provides access to interior compartment 23. Handle 15 has an interior wall 29 which projects slightly inward at its approximate midpoint to form an interior shelf, or inwardly-protruding lip, 31 that serves as a surface for engaging and retaining a handheld instrument retained within compartment 23.

An annular, external flange 33 protrudes outward from the outer surface of handle 15 proximate top end 27 and serves as an abutment surface for receiving cap 17. A pair of tab-like twist threadings 35 is formed on outer surface of handle 15 above flange 33 and facilitate securement of cap 17 onto handle 15. Additionally, a pair of holes 37-1 and 37-2 extends laterally through handle 15 proximate bottom end 25 and align with holes 21-1 and 21-2, respectively, of pole 13 to facilitate the coupling of components using rivet-type fastening elements 39.

Preferably, an insert is mounted within cavity 23 at bottom end 25 to provide structural rigidity within the region of connection between handle 15 and pole 13. Additionally, an insert would serve as a bottom wall, or stop, within interior compartment 23 and thereby prevent an item retained therein from extending below handle 15 (i.e., towards first end 13-1 of pole 13).

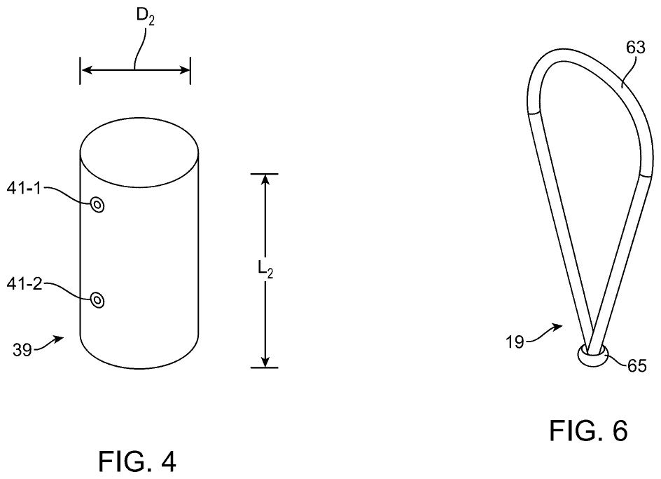

For example, in FIG. 4, a solid, wooden spacer 39 is shown in isolation. Spacer 39 has a length L₂ of approximately 2 inches and an outer diameter D₂ of 1.068 inches, thereby rendering spacer 39 suitably dimensioned for fitted insertion within bottom end 25 of handle 15. Spacer 39 is shown with a pair of laterally-extending holes 41-1 and 41-2. As can be appreciated, holes 41 align with both holes 37 in handle 15 and holes 21 in pole 13 to facilitate the assembly and connection of components using rivets 39.

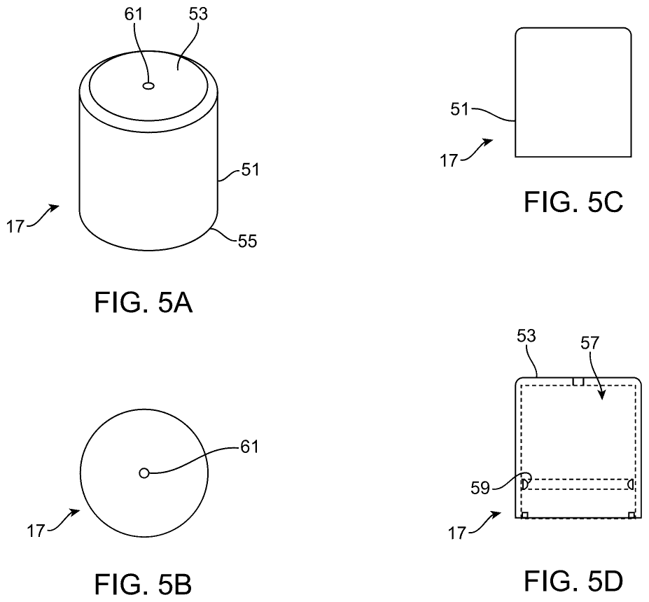

Referring now to FIGS. 5A-5D, cap 17 is a unitary component that is preferably constructed of a rigid and durable material, such as a co-polymer polypropylene. Cap 17 comprises a generally cylindrical sidewall 51 with an enclosed top end 53 and an open bottom end 55. Together, sidewall 51 and top end 53 define an interior cavity 57 which is accessible through open bottom end 55.

Cap 17 has an overall length L₃ of approximately 2.199 inches and an outer diameter D₃ of approximately 1.985 inches. As can be appreciated, cap 17 is dimensioned to telescopingly mount over open top end 27 of handle 15, thereby enclosing interior compartment 23. As such, it is to be understood that a portion of an item retained within handle 15 may project into interior cavity 57 of cap 17.

An annular projection, or ring, 59 is integrally formed on inner surface of cap 17 proximate open bottom end 55. Ring 59 is designed to selectively engage twist threadings 35 on handle 15. More specifically, cap 17 is designed to coaxially mount over open top end 27 of handle 15 such that bottom end 55 of cap 17 abuts against annular flange 33 on handle 15. Then, by rotating cap 17 clockwise about its longitudinal axis, ring 59 firmly engages threadings 35 on handle 15 and thereby retains cap 17 mounted onto handle 15. To subsequently remove cap 17 from handle 15, cap 17 is rotated in the counterclockwise direction about its longitudinal axis such that ring 59 in cap 17 disengages from threadings 35 on handle 15.

A small hole 61, approximately 0.15 inches in diameter, is preferably formed in the center of enclosed top end 53. Hole 61 is provided to facilitate the connection of paracord loop 19 to cap 17.

More specifically, as seen in FIG. 6, paracord loop 19 includes a length of 2 mm cord 63 which is formed into a closed loop. The ends of cord 63 are double knotted together to form an enlargement, or knot, 65 that is preferably 0.316 inches in diameter. Accordingly, cord 63 of paracord loop 19 is designed to project through hole 61 in cap 17 and be pulled away such that knot 65 abuts firmly against the inner surface of top end 53. In this manner, paracord loop 19 serves as a means for hanging pole assembly 11 onto a hook or other similar structure for storage purposes.

### Use of Pole Assembly 11 to Retain a Small Handheld Instrument

As noted above, pole assembly 11 is designed to function as an elongated handle for a multi-purpose gardening tool. Additionally, as a principal novel feature of the present invention, pole assembly 11 is designed to retain a small handheld instrument within interior compartment 23 of handle 15 and thereby expand the scope of its available gardening functions.

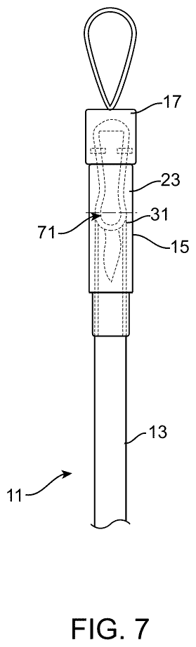

Referring now to FIG. 7, pole assembly 11 is shown with a small handheld instrument 71 disposed within interior compartment 23. As can be seen, the inward protrusion of shelf 31 within compartment 23 limits the downward displacement of instrument 71 within handle 15.

Cap 17 is shown secured to handle 15, thereby retaining instrument 71 fixed in place within compartment 23. To access instrument 71, cap 17 is twisted in the counterclockwise direction, thereby disengaging cap 17 from handle 15. Thereafter, cap 17 can be removed from handle 15 and instrument 71 can be readily accessed from compartment 23. Upon completion of its use, instrument 71 can be returned to compartment 23 and cap 17 resecured to handle 15 until further use is required.

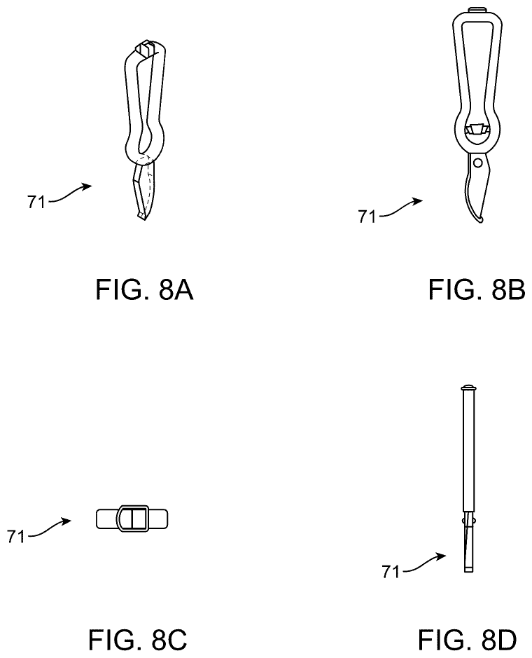

Instrument 71 is represented herein as a pair of pruning clippers. As seen most clearly in FIGS. 8A-8D, instrument has a length L₄ of approximately 6.535 inches and a width W of approximately 1.483 inches. The relative size and shape of instrument 71 renders it particularly well suited for removable storage from within handle 15 of pole assembly 11. However, as referenced above, alternative items could be similarly retained within pole assembly 11 without departing from the spirit of the present invention.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A pole assembly for a handheld gardening tool, the pole assembly comprising:
(a) an elongated tubular pole having a first end and a second end;
(b) a handle, the handle being hollowed out along its length so as to define an interior compartment, the handle having an open, inwardly tapered, bottom end and an open, widened, top end, the bottom end being mounted over the second end of the elongated tubular pole in a telescoping fashion, the handle having an interior wall that includes an inwardly-protruding lip; and
(c) a cap removably mounted onto the top end of the handle so as to enclose the interior compartment;
(d) wherein the interior compartment of the handle is adapted to receive a small handheld gardening instrument.

2. The pole assembly as claimed in claim 1 further comprising a solid, cylindrical insert fittingly mounted within the interior compartment of the handle at the bottom end.

3. The pole assembly as claimed in claim 2 wherein at least one rivet-type fastening element is driven transversely through the pole, the handle, and the insert to secure interconnection.

4. The pole assembly as claimed in claim 3 wherein the handle has an outer surface that is textured to facilitate gripping.

5. The pole assembly as claimed in claim 4 wherein the handle is generally frustoconical in shape.

6. The pole assembly as claimed in claim 5 wherein the interior compartment is adapted to receive one from the group consisting of gardening clippers and pruning shears.

7. The pole assembly as claimed in claim 6 wherein the pole is hollowed out along its length.

8. The pole assembly as claimed in claim 4 wherein a threading is formed on the outer surface of the handle proximate the open, widened, top end.

9. The pole assembly as claimed in claim 8 wherein the cap includes a generally cylindrical sidewall with an enclosed top end and an open bottom end.

10. The pole assembly as claimed in claim 9 wherein the cap has an inner surface which is shaped to include an annular projection, the annular projection releasably engaging the threading on the handle to retain the cap in place on the open top end of the handle.

11. The pole assembly as claimed in claim 10 wherein an annular, external flange protrudes outward from the outer surface of the handle towards the open, widened, top end.

12. The pole assembly as claimed in claim 11 wherein the external flange on the handle serves as an abutment surface when mounting the cap onto the top end of the handle.

13. The pole assembly as claimed in claim 12 further comprising a paracord loop secured to the cap.

14. The pole assembly as claimed in claim 13 wherein a hole is formed in the center of the enclosed top end of the cap.

15. The pole assembly as claimed in claim 14 wherein a portion of the paracord loop is inserted through the hole in the cap, the paracord loop including an enlarged knot disposed against the enclosed top end of the cap to prevent disconnection.
